(19) United States
(12) Patent Application Publication
(10) Pub. No.: US 2008/0307972 A1
(43) Pub. Date: Dec. 18, 2008

(54) AIR PURIFIER AND LIGHT

(76) Inventor: Dan L. DIETZ, Houston, TX (US)

Correspondence Address: PILLSBURY WINTHROP SHAW PITTMAN, LLP, P.O. BOX 10500, MCLEAN, VA, 22102, US

(21) Appl. No.: 12/138,888

(22) Filed: Jun. 13, 2008

Related U.S. Application Data
(60) Provisional application No. 60/944,368, filed on Jun. 15, 2007.

(51) Int. Cl. B03C 3/32

(52) U.S. Cl. 96/15

(57) ABSTRACT

An illuminating air purifier is disclosed. In an embodiment, the illuminating air purifier includes an air ionizer, a back plate, and a light.

This application claims priority to U.S. Provisional Application No. 60/944,368, the entirety of which is hereby incorporated herein.

### BACKGROUND OF THE INVENTION

1. Field of the Invention

This invention relates to the field of air purifiers, more specifically to air purifiers with lights.

2. Background of the Invention

Air purifiers are commonly used to remove air contaminants from areas such as household rooms. Different types of air purifiers have been used to remove such contaminants. Drawbacks to conventional air purifiers include inefficiencies in their attachments to articles for use. For instance, inefficiencies in their attachment to a room wall.

Consequently, there is a need for an improved air purifier. Further needs include improved air purifier methods for attachment.

### BRIEF SUMMARY OF SOME OF THE PREFERRED EMBODIMENTS

These and other needs in the art are addressed in one embodiment by an illuminating air purifier that includes an air ionizer, a back plate, and a light.

The foregoing has outlined rather broadly the features and technical advantages of the present invention in order that the detailed description of the invention that follows may be better understood. Additional features and advantages of the invention will be described hereinafter that from the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an illuminating air purifier comprising an air filter with back plate and light unattached; and

FIG. 2 illustrates the illuminating air purifier of FIG. 1 with the light and back plate attached to the air purifier.

### DETAILED DESCRIPTION OF THE PREFERRED EMBODIMENTS

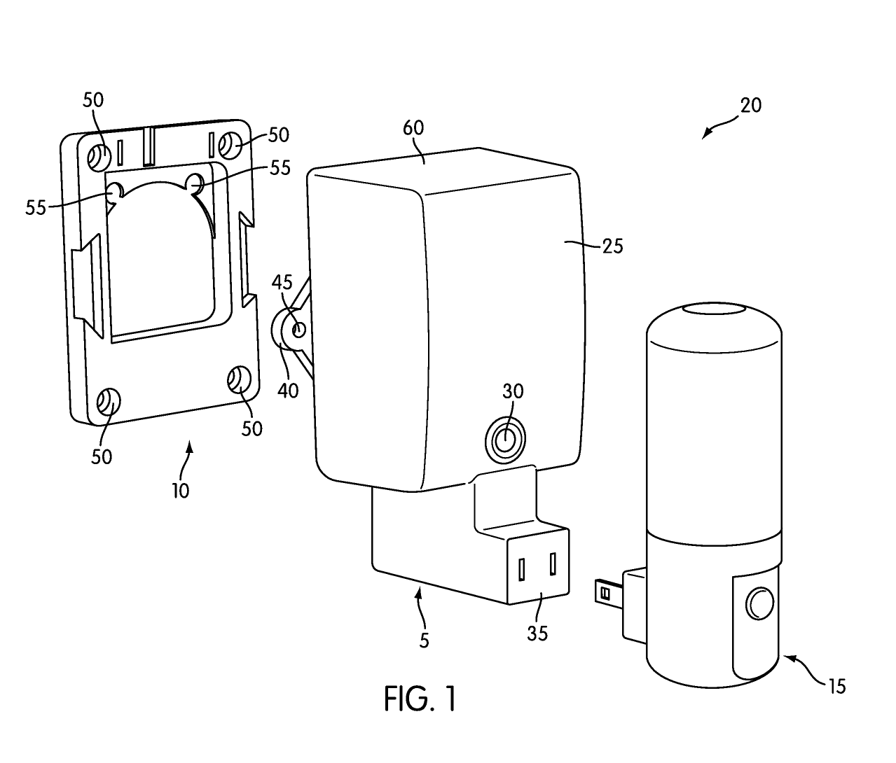

FIG. 1 illustrates illuminating air purifier 20 comprising air purifier 5, back plate 10, and light 15. Air purifier 5 may include any air purifier suitable for use in removing contaminants and/or odors from the air within and/or around any item (e.g., a wall, toilet, cage, and the like). Without limitation, examples of suitable air purifiers include mechanical filter devices, absorbent devices (e.g., devices that filter air through absorbents such charcoal), and air ionizers. Any air ionizer suitable for removing particulate and/or odors from the environment (e.g., air) may be used. An example of an air ionizer is an electrostatic precipitator. Electrostatic precipitators refer to a particulate collection device that removes particles from air using the force of an induced electrostatic charge. In some embodiments, produced ions exit the air ionizer and migrate through the air by ionic flow. Without limitation, examples of commercial electrostatic precipitators include the NATURAL AIR and HYBRID GP. The NATURAL AIR is an electrostatic precipitator commercially available horn Natural Air Systems, Inc. HYBRID GP is an electrostatic precipitator commercially available from THE SHARPER IMAGE. The air purifier may be disposed at any suitable location on the particular item by which the air purifier may remove particulate and/or reduce odor from the air within and/or around the item. For instance, one or more air purifiers may be attached to a wall. The air purifier may also include the air purifier and applications thereof disclosed in U.S. patent application Ser. No. 11/563,650, which is incorporated by reference herein in its entirety.

In an embodiment, air purifier 5 includes housing 25, an entrance port (not illustrated), exit port 30, and electrical socket 35. In such an embodiment, air purifier 5 is an air ionizer. Air purifier 5 may also optionally include at least one wing surface 40. In some embodiments, air purifier 5 has two wing surfaces 40 with a wing surface 40 (not illustrated) on the opposite side of housing 25 from the wing surface 40 illustrated in FIG. 1. A fan (not illustrated) is disposed within housing 25. The fan may be powered by any suitable source such as by battery or from an available electric supply (e.g., from a wall socket). Air purifier 5 operates to draw air in through the entrance port into housing 25. Ions are produced and exit through exit port 30. In a11 embodiment, exit port 30 has a smaller diameter than the entrance port. Without being limited by theory, ions are produced from the air inside housing 25 by venturi effect and exit through exit port 30. 111 an embodiment in which air purifier 5 has at least one wing surface 40, wing surface 40 may be used to attach air purifier 5 to a surface. For instance, a nail or a screw may be inserted through wing opening 45 to secure air purifier 5 to the surface (e.g., a wall).

As shown in FIG. 1, light 15 may be inserted into electrical socket 35. Upon electrical flow through air purifier 5, electrical socket 35 may provide electricity to light 15, which may then emit light. Light 15 may include any suitable light such as a light emitting diode (LED).

In an embodiment, air purifier 5 further includes an electrical plug (not illustrated). The electrical plug may be inserted into an electrical socket (not illustrated) to provide electrical power to air purifier 5 and optionally to light 15.

In some embodiments, back plate 10 is secured to air purifier 5. Back plate 10 may be attached to a surface through attachment openings 50. For instance, nails or screws (not illustrated) may be inserted through attachment openings 50 to secure back plate 10 to the surface (e.g., a wall). In an embodiment, back plate 10 may also include hooks (not illustrated) that may be used to attach back plate 10 to an item such as a cage. In some embodiments of such embodiment, the hooks may be embedded in back plate 10 and may be released by spring action to allow back plate 10 to attach to the item. Air purifier 5 may be secured to back plate 10 by any suitable means. In an embodiment as shown in FIG. 1, attachment means (not illustrated) on back side 60 of air purifier 5 slide up and through back plate receiving means 55 to secure air purifier 5 to back plate 10. The attachment means may be any suitable means for attaching air purifier 5 such as suction I cups and the like.

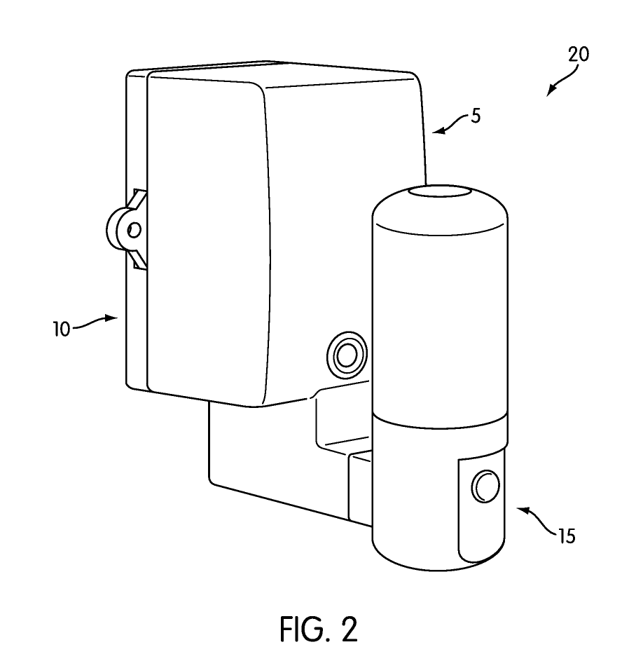

As shown in FIG. 2, illuminating air purifier 20 includes back plate 10 secured to air purifier 5 with light 15 plugged into air purifier 5.

Although the present invention and its advantages have been described in detail, it should be understood that various changes, substitutions aid alterations may be made herein without departing from the spirit and scope of the invention as defined by the appended claims.

What is claimed is:

1. An illuminating air purifier, comprising:
an air ionizer;
a back plate; and
a light.
